(19) United States
(12) Patent Application Publication
(10) Pub. No.: US 2026/0309231 A1
(43) Pub. Date: Oct. 8, 2026

(54) MAINTENANCE HOLE CONNECTION SEAL

(71) Applicant: S&B Technical Products, Inc., Fort Worth, TX (US)

(72) Inventors: Rodney Pacheco, San Pedro (CR); Guido Quesada, Santa Ana (CR)

(73) Assignee: S&B Technical Products, Inc., Fort Worth, TX (US)

(21) Appl. No.: 19/098,525

(22) Filed: Apr. 2, 2025

(51) Int. Cl. F16J 15/3268; F16J 15/3204; F16L 17/02

(52) U.S. Cl. CPC F16J 15/3268; F16J 15/3204; F16L 17/02

(57) ABSTRACT

A connection seal for effecting a fluid tight seal between a pipe and an opening in the wall of a structure such as a manhole or maintenance collection tank in a sewer system. The connection seal includes a ring-shaped elastomeric body which has a resilient circumferential tension region located at an approximate mid-point of the elastomeric body which tension region joins a pair of oppositely arranged, pipe aligning cone regions on a bottom circumferential surface of the connection seal. The pipe aligning cone regions each terminates in an outer circumferential lip region at an outer extent thereof. The outer circumferential lip regions extending outwardly at an acute angle with respect to the bottom circumferential surface of the connection seal elastomeric body. The outer circumferential lip regions are each connected by valley region to an inwardly extending rocker-type element on an upper circumferential surface of the connection seal body, the inwardly extending rocker-type elements forming an obtuse angle with respect to the oppositely arranged grabbing handles. The rocker-type elements are separated by a lodging space designed to receive a variable thickness tank wall.

### BACKGROUND OF THE INVENTION

### 1. Field of the Invention

The present invention relates generally to a connection seal for achieving a fluid tight seal between a pipe and an opening in the wall of a structure, particularly, an underground structure such as a maintenance hole or manhole of the type used in the waterworks industries.

### 2. Description of the Prior Art

Various seal designs are used to provide fluid tight connections between pipes and structures in a variety of underground pipeline systems. For example, they are used in septic tank systems and in the fluid distribution boxes used in municipal water and sewer distribution systems. Underground structures of this type are sometimes referred to as “manholes” or “maintenance holes,” and these terms will be used interchangeably in the discussion which follows. These structures are commonly made of rigid plastic, cast concrete, fiberglass, or metal and include a plurality of walls having one or more openings through which pipes extend. The seal elements or seal assemblies are used to provide fluid tight seals between the wall openings and the outer surfaces of the pipes.

In sewer lines, manholes are ordinarily installed at various intervals including locations where the sewer line changes elevation or direction. For many years, manholes have historically been formed in molds from a settable material such as concrete. The mold may form one or more annular openings in the sidewalls of the manhole in which sewer pipes are positioned to lie adjacent a wall of the manhole defining that particular opening. Also, openings are often cut in the sidewalls of the manhole in the field, after manufacture at the plant. The joint between the manhole wall and outer surface of the sewer pipe is sealed to prevent ground water from entering the manhole and to prevent contents of the manhole, such as sewage and water, from leaking out of the manhole. When ground water enters the manhole, it often brings in sediment which collects in the sewer over time. Such sediment causes clogs and inhibits the ability of the manhole to carry water. In addition, infiltration of ground water also increases the total volume of sewage flow through sewer lines which increases the required size of pipe needed as well as the expense of treatment of the total sewage flow. When the contents of the manhole leak, they can pollute the ground water.

Concrete maintenance holes structures are typically formed with relatively thick walls. One type of seal used with concrete structures in the past are the so-called “cast-in-place” gaskets. These gaskets are often made entirely of a resilient material such as rubber. Cast-in-place gaskets typically include an annular body having an outwardly-projecting anchor component or flange which is cast within the concrete of the wall of the underground structure such that, when the concrete cures, the flange is embedded within the cured concrete to firmly anchor the gasket within the wall opening. Cast-in-place gaskets typically also include either an inwardly-projecting sealing projection or lobe for providing a compressive seal with the outer surface of a pipe, or a resilient boot portion which is clamped to the outer surface of the pipe with a take-down clamp to form a sealed connection. Some gaskets may include both type of seals.

Expansion-type gaskets are another commonly used type of gasket for concrete manhole applications. The typical expansion-type gasket includes an annular body which, after being placed within the opening in the structure wall, is radially expanded outwardly by an expansion ring assembly to compressively seal the gasket against the wall opening. Once this is accomplished, a take-down clamp is used to clamp a boot portion of the gasket against the outer surface of a pipe to form a sealed connection.

Today, manholes and maintenance tanks are commonly manufactured from various rigid plastic materials. The manholes for which the present connection seal was particularly designed are made of polyethylene, typically by rotational molding, or rotomolding. These tanks have sidewalls on the order of about 12 to 19 mm thick. The relatively complex geometry of these tanks would be difficult to achieve in cast concrete. Also, in this 12-19 mm wall thickness there would be no room to put a cast-in-place gasket.

One of the design challenges with plastic tanks is that, due to the manufacturing process, the resin tends to flow towards the bottom of the tank, so the wall thickness tends to increase towards the bottom. This can produce this variation in wall thickness between 12 and 19 mm in the same wall, thinner at the top of the hole, thicker at the bottom. This poses a challenge for the connection seal design.

The plastic tanks are produced without holes. Then a large core drill or an electric hand saw is used to make holes on predefined flat walls for different pipe diameters. Again, this makes it impractical to use a cast-in-place gasket. The method used to make the holes can lead to a relatively rough surface finish, which is not adequate for sealing. However, the inner and outer walls of the plastic tank are relatively smooth. This makes them the best surfaces for sealing purposes. The connection gasket of the invention is intended to seal against these relatively smoother pipe surfaces.

What is needed is a connection seal for providing a fluid tight seal between a pipe and an opening in a structure, particularly wall of a manhole or maintenance hole structure, which is an improvement over the known art.

### SUMMARY OF THE INVENTION

The present invention is a maintenance hole connection seal for establishing a seal between an incoming pipe and a hole in a collection tank or other structure, such as a hole in a manhole or maintenance collection tank of the type found in a sewer system. The connection seal has a ring-shaped elastomeric body, the elastomeric body having a resilient circumferential tension region located at an approximate mid-point of the elastomeric body which tension region joins a pair of oppositely arranged, pipe aligning cone regions on a bottom circumferential surface of the seal ring body. The pipe aligning cone regions each terminate in an outer circumferential lip region at an outer extent thereof. The outer circumferential lip regions extend outwardly at an acute angle with respect to the bottom circumferential surface of the seal elastomeric body.

The outer circumferential lip regions are each connected by valley region to an inwardly extending rocker-type element on an upper circumferential surface of the connection seal body. The inwardly extending rocker-type elements form an obtuse angle with respect to the oppositely arranged outer circumferential lip regions. The rocker-type elements can be separated by a lodging space designed to receive a variable thickness tank wall, but normally touch in the relaxed state. The lodging space created between the two rocker-type elements includes a vertical opening and oppositely arranged side void regions. The elastomeric body, tension region, pipe aligning cone regions and outer circumferential lip regions, and rocker-type elements can all be integrally formed of a homogeneous resilient elastomeric material.

Preferably, each of the rocker-type elements has an upper tank wall sealing rib formed in an inner circumferential region thereof, the inner circumferential region being located above a respective void region. The elastomeric body, tension region, pipe aligning cone regions and outer circumferential lip regions, and rocker-type elements can be manufactured by known extrusion processes, such as an extrusion process where a strip is extruded and cut to a given length which defines a pair of free ends, the free ends then being joined to form a ring-shaped body.

A region on the bottom circumferential surface of the elastomeric body of the connection seal joins the tension region to the outer circumferential lip regions and extends at an upward angle on either side of the tension region to thereby form a pipe aligning cone region when a chamfered region of a plastic pipe is inserted within the connection seal. The bottom circumferential surface of the connection seal body defines a central, pipe receiving opening, and wherein the pipe aligning cone regions on the bottom circumferential surface of the seal ring body terminate at pipe sealing surfaces at a point at which each of the cone regions joins the tension region of the connection seal body. A vertical axis drawn to bisect the tension region of the connection seal body divides the body into a pair of symmetrical shapes, thereby providing sealing redundancy for the connection seal.

A method is also shown for establishing a seal between an incoming pipe and a hole in a maintenance hole collection tank using the previously described seal. The collection tank has interior and exterior sidewalls and at least one hole which is cut in a sidewall of the collection tank, the hole having a rough cylindrical edge left by the cutting of the hole. As has been described, the lodging space created between the two rocker-type elements of the connection seal includes a vertical opening and oppositely arranged side void regions. The seal is installed in the previously provided hole in the tank wall of the maintenance hole collection tank so that it seals against flat surfaces of the tank interior and exterior walls rather than on the rough edge of a cylindrical wall opening in the collection tank wall. The fact that the seal features a mirrored geometry on both inside and outside, creates redundancy of the sealing points.

The connection seal of the invention is designed to be installed over variable wall thicknesses while maintaining contact around an entire circumferential surface of the hole opening in the collection tank. The preferred seal also incorporates a receiving and aligning cone geometry that ensures the alignment of the incoming pipe which is received within the tank opening, the aligning cone geometry interacting with the pipe chamfer to guide the pipe into the correct position for assembly.

During a first stage of pipe-seal interaction during assembly of the connection seal within the collection tank opening, the seal's cone angles and diameter of the contact surface of the ring within the tank opening ensures that, under low-friction conditions, an outer part of the seal expands over the pipe spigot while the seal retracts in a direction which is opposite to the direction of the spigot's movement. Also, this first stage of pipe-seal interaction pulls an inner section of the seal via the tension region of the seal, whereby the seal climbs over the spigot, opening its internal diameter and pulling the tension region against the insertion direction. In a second stage of the assembly, the pipe spigot pushes against and opens the inner section of the connection seal, stretching the tension region even further. Once assembly is finished, the stretch in the tension region of the seal serves to increase the contact pressure against both the tank wall and the pipe. The tension region of the seal helps to balance forces when opposite load conditions occur on the inside and outside, such as in specific areas of the seal during deflection of the incoming pipe spigot end.

These steps in the seal assembly process are described in the Drawings of the case and in the written description which follows.

Additional objects, features and advantages will be apparent in the written description which follows.

### BRIEF DESCRIPTION OF THE DRAWINGS

FIGS. 1A and 1B are perspective views of a portion of a structure, showing a fluid tight connection between a pipe and an opening in a wall of the structure sealed in accordance with the teachings of the present invention.

FIG. is a partial, perspective view of a maintenance box of the type used in the waterworks industry, showing the use of the manhole connection seal of the invention.

FIG. 3 is a simplified top view of the maintenance box of FIG. 2 showing further details of the manhole connection seal in use.

FIG. 4 is a side, cross sectional view of the manhole connection seal of the invention, shown in isolated fashion.

FIG. 4A is a view, similar to FIG. 4, of another version of the connection seal of the invention.

FIG. 5 is another simplified view of the manhole connection seal of the invention in use, showing the placement on the hole in the associated structure being sealed.

FIG. 6-9 are perspective views of the manhole connection seal of the invention installed in a hole in a maintenance box and showing the various stages of the insertion of a plastic pipe to effect the sealed connection.

FIG. 10-15 are side sectional views of the manhole connection seal of the invention further illustrating the placement of the seal in a hole in a sidewall of a structure and subsequent placement of a plastic pipe in sealing engagement with the hole.

### DETAILED DESCRIPTION OF THE INVENTION

The preferred version of the invention presented in the following written description and the various features and advantageous details thereof are explained more fully with reference to the non-limiting examples included and as detailed in the description which follows. Descriptions of well-known components and processes and manufacturing techniques are omitted so as to not unnecessarily obscure the principal features of the invention as described herein. The examples used in the description which follows are intended merely to facilitate an understanding of ways in which the invention may be practiced and to further enable those skilled in the art to practice the invention. Accordingly, the examples should not be construed as limiting the scope of the claimed invention.

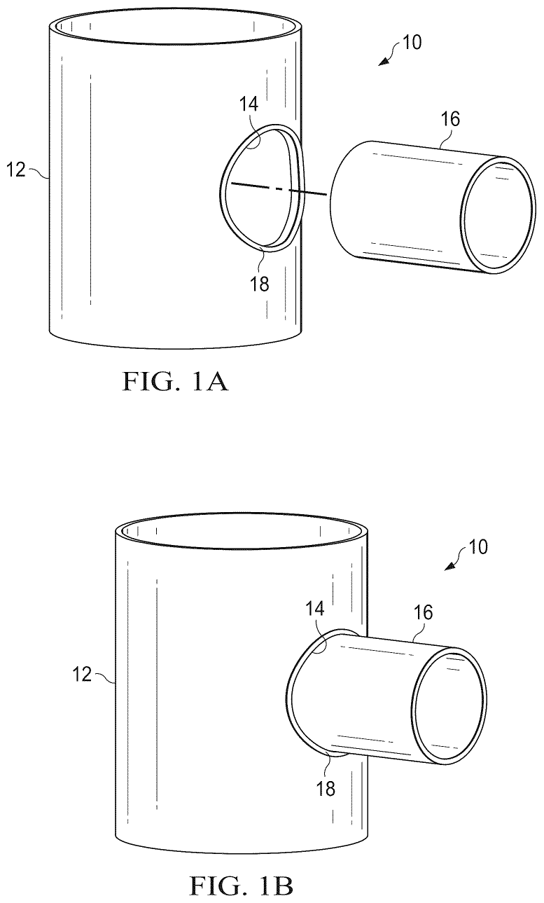

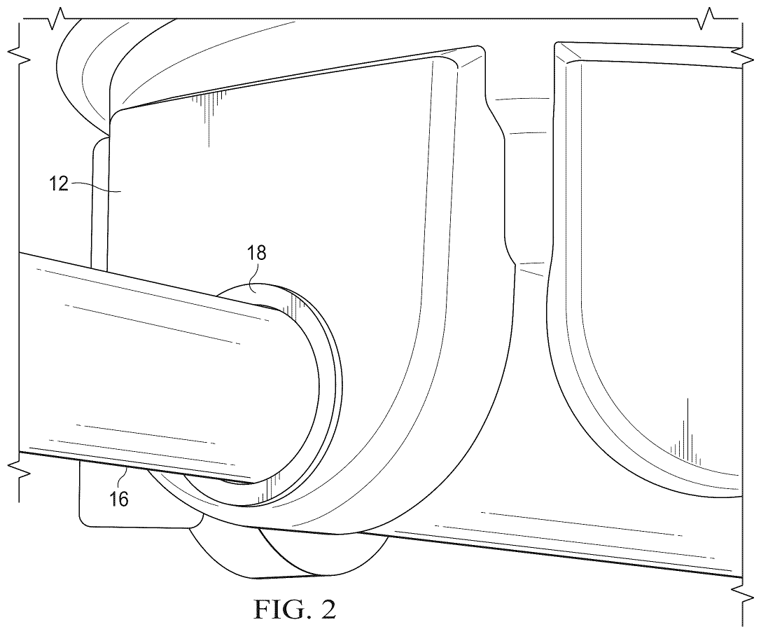

The maintenance hole connection seal of the invention is intended for non-pressure applications, such as for connecting sewer pipelines to a collection tank (as shown in simplified fashion in FIGS. 1A and 1B). The connection seal can conveniently be manufactured by extruding a profile, which is then cut and spliced to form a ring of several sizes to fit various hole diameters cut into the collection tank wall to accommodate the corresponding incoming pipes (e.g. 160, 200, 250, and 315 mm). Typically, the hole in the tank is cut in the field using basic methods that leave rough edges unsuitable to seal against.

As explained in the Background discussion, due to the manhole manufacturing process, the wall thickness of the typical collection tank varies between about 12 mm and 19 mm for plastic tanks of the type under consideration. The connection seal must adjust to provide a tight fit despite these variations in wall thickness, ensuring a secure seal between the manhole wall and the incoming pipes. The seal must also adapt to ensure a proper seal against incoming pipes, where the pipes may be deflected at an angle between about 3° and 7° to the horizontal. In addition to these conditions, the connection seal must withstand a vacuum and pressure performance requirements of −0.7 Bar and +0.5 Bar respectively.

Referring back FIGS. 1A and 1B, a portion of an underground structure 10 is shown, such as a septic tank or a fluid distribution box, such structures sometimes being referred to as “manholes” or “maintenance holes.” Structure 10 includes wall 12 having a circular opening 14 through which a pipe 16 is inserted. Structure 10 is typically formed of a rigid plastic material, but may in some cases be formed of cast concrete, or of a metal, fiberglass or other suitable material, considering the end application. As described in further detail below, a connection seal 18 according to the present invention is used to provide a fluid tight seal between opening 14 in wall 12 and pipe 16. While the invention has been described with respect to plastic maintenance and manhole tanks, it will be understood that the design could conceivably be used for sealing with other types of walls, aside from tanks or manholes. For example, the opening could be on a building wall, where it is often necessary to put pipes through walls while ensuring the connection to the wall remains water tight, weather tight or air tight.

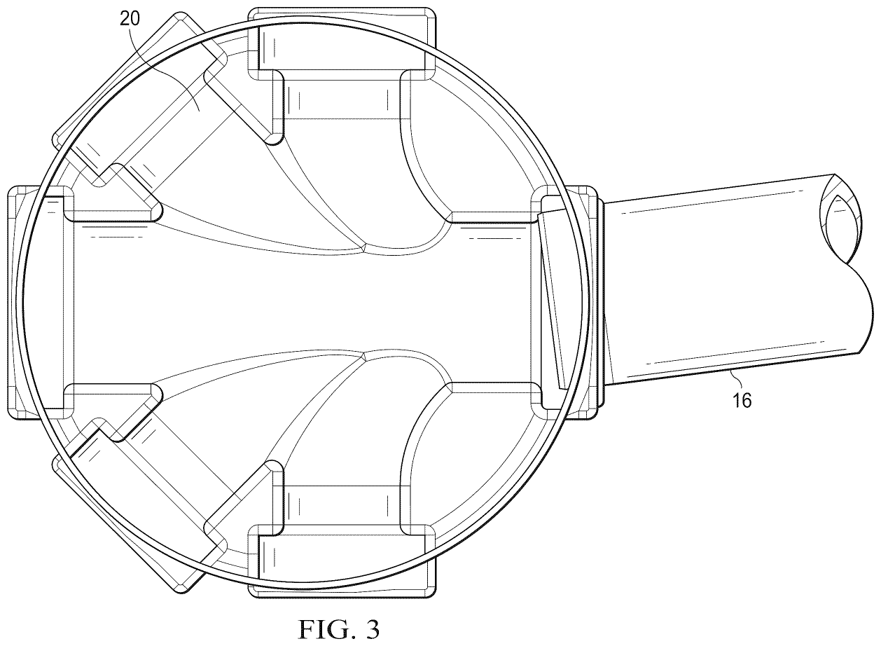

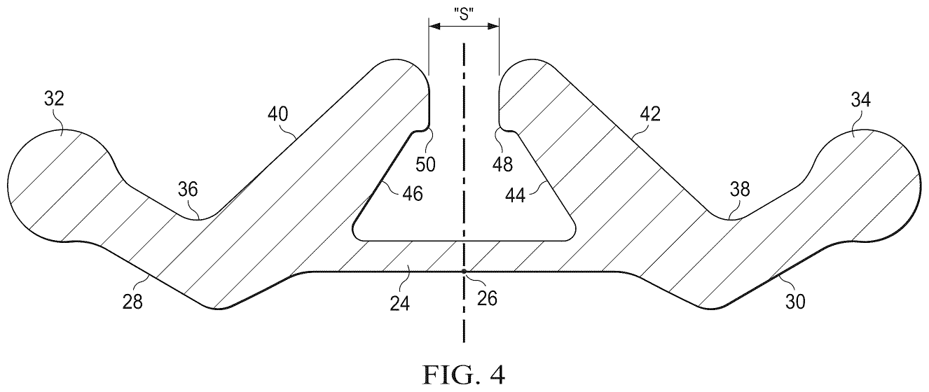

FIGS. 2 and 3 are further illustrations of maintenance hole collection tanks or boxes of the type widely used in present waterworks installations. The image in FIG. 2 is typical of a rotomolded plastic tank. This relatively complex geometry would be difficult to achieve in cast concrete. In the installation shown in FIG. 3, the pipe 16 is connected to a fluid manifold arrangement 20 within the plastic collection tank. It should be noted from the view shown in FIG. 2, and particularly in the view of FIG. 3, that the incoming pipe 16 is at an angle to the sidewall of the tank 12.

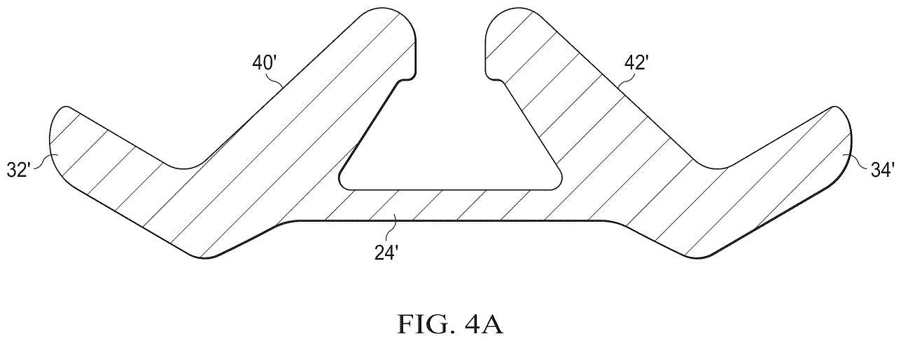

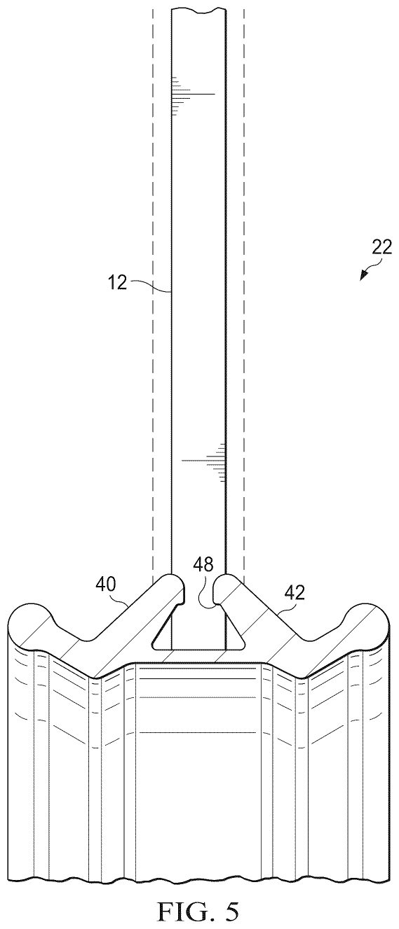

FIGS. 4 and 5 are cross sectional views of the improved connection seal of the invention, designated generally as 22. The elastomeric material used to form the body of the connection seal will vary in composition depending upon the end application but may encompass a number of different natural and synthetic rubbers including, for example, styrene butadiene rubber (SBR), ethylene propylene diene rubber (EPDM), acrylonitrile-butadiene rubber (NBR), nitrile rubber, etc.. A natural or synthetic rubber having a hardness on the order of 40-50 durometer has been found to provide an acceptable degree of deformability of the seal. As has been mentioned, the connection seal 22 can be formed by extrusion as a strip, with the strip being cut to various lengths. The resulting free ends of the seal can then be joined by fusion, gluing, or other convenient means know in the industry. The connection seal 22 is thus preferably formed as an integral, homogeneous elastomeric body.

The pipe 16 which is being sealed could be formed of a variety of materials, but is preferably formed of any of a variety of commercially available thermoplastic materials, such as the polyolefin family including polyethylene and polypropylene as well as polyvinyl chloride and similar materials. Thermoplastic pipes of this general type are used in a variety of industrial settings including water, sewage and chemical industries and will be well familiar to those skilled in the relevant arts.

As shown in FIG. 4, the connection seal 22 is a ring-shaped elastomeric body, the elastomeric body having a resilient circumferential tension region 24 located at an approximate mid-point 26 of the elastomeric body, extending in a horizontal plane, as viewed in FIG. 4, on either side of the midpoint 26. The tension region 24 joins a pair of oppositely arranged, pipe aligning cone regions 28, 30, on a bottom circumferential surface of the seal ring body. The pipe aligning cone regions 28, 30, each terminate in an outer circumferential lip region 32, 34, at an outer extent thereof. The outer circumferential lip regions 32, 34, extending outwardly at an acute angle with respect to the bottom circumferential surface of the seal elastomeric body and form bulbous protrusions at their outer extents.

FIG. 4A is a view of an alternative version of the connection seal of the invention. It is similar in most respects to the version of FIG. 4 with corresponding parts designated by primes. In the case of the seal of FIG. 4, the outer circumferential lip regions 32, 34, present a “bulbous” shape in cross section. In the version of FIG. 4A, these corresponding regions 32′, 34′, present a smoothly tapering appearance.

With further reference to FIG. 4, the outer circumferential lip regions 32, 34, are each connected by valley region 36, 38, to an inwardly extending rocker-type element 40, 42, on an upper circumferential surface of the seal ring body. As is evident in FIG. 4, the inwardly extending rocker-type elements 40, 42, form an obtuse angle with respect to the oppositely arranged lip regions 32, 24. The rocker-type elements 40, 42, are separated by a lodging space designated as “S” in FIG. 4, which is sized to receive a variable thickness tank wall. The space “S” may actually be closed up in the relaxed state of the seal. FIG. 5 shows a portion of the tank wall 12 being received between the two oppositely arranged rocker-type elements 40, 42. As can also be seen in FIG. 4, the lodging space created between the two rocker-type elements 40, 42, includes a vertical opening for receiving a portion of the tank wall 12 and oppositely arranged side void regions (generally at 44 and 46). Each of the rocker-type elements 40, 42, has an upper tank wall sealing rib 48, 50, formed in an inner circumferential region thereof, the inner circumferential region being located above a respective void region 44, 46.

As has been mentioned, the region 28 on the bottom circumferential surface of the elastomeric body of the connection seal joining the tension region 14 to the outer circumferential lip region 32 forms a pipe aligning cone region when a chamfered region of a plastic pipe is inserted within the connection seal. The bottom circumferential surface of the seal ring body defines a central, pipe receiving opening (generally at 48 in FIG. 5), and wherein the pipe aligning cone regions on the bottom circumferential surface of the seal ring body terminate at pipe sealing surfaces at a point at which each of the cone regions joins the tension region of the seal body. A vertical axis (such as the axis passing through mid-point 26 in FIG. 4) drawn to bisect the tension region 24 of the gasket body divides the body into a pair of symmetrical shapes, thereby providing sealing redundancy for the connection seal.

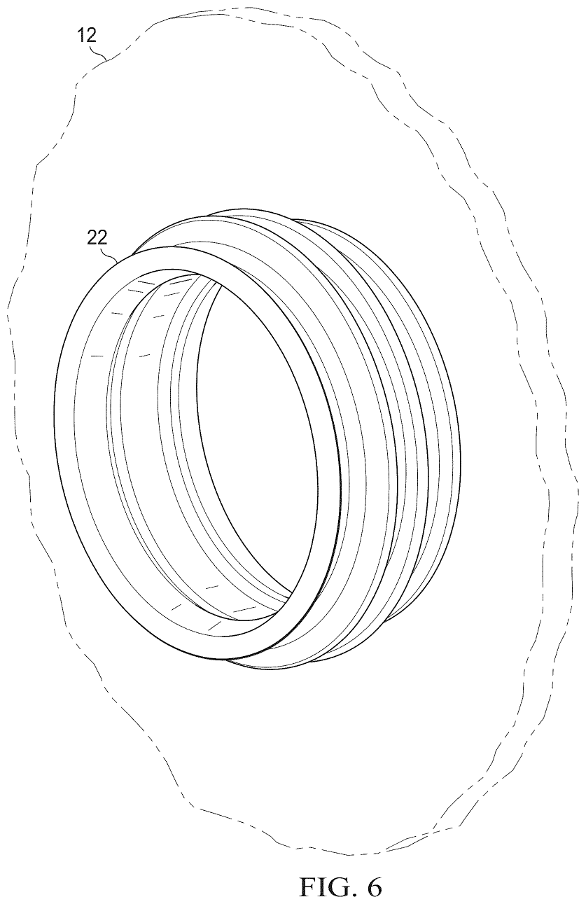

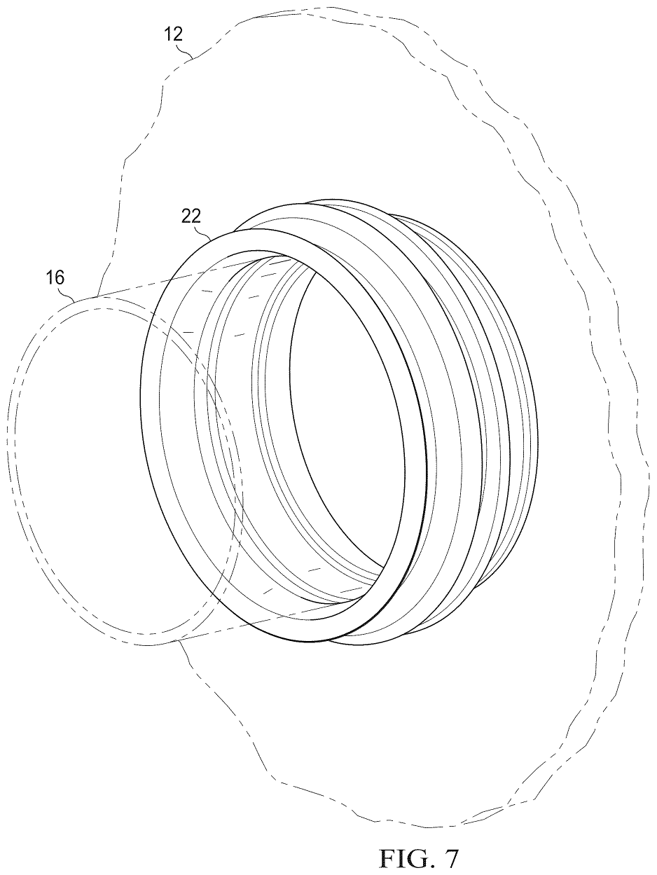

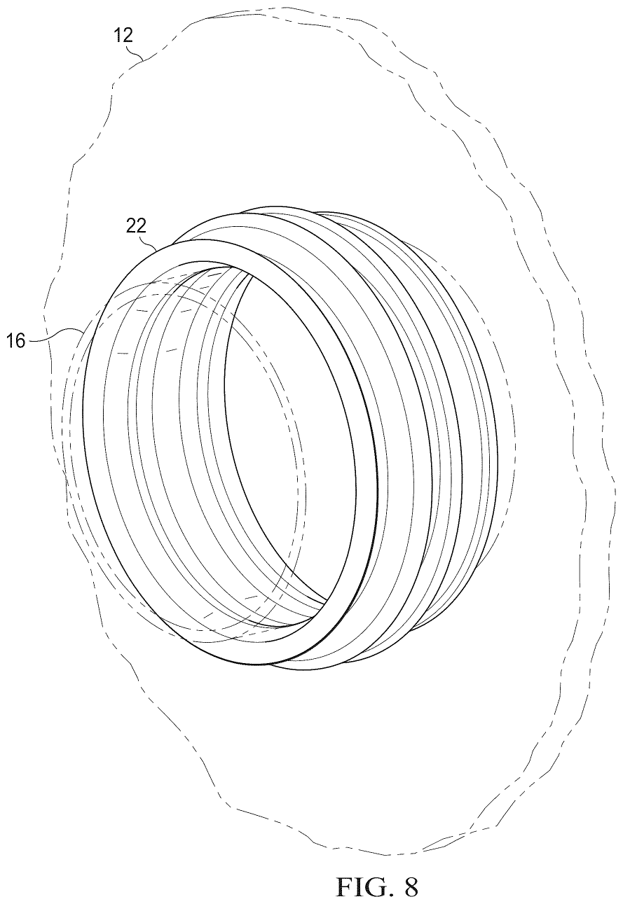

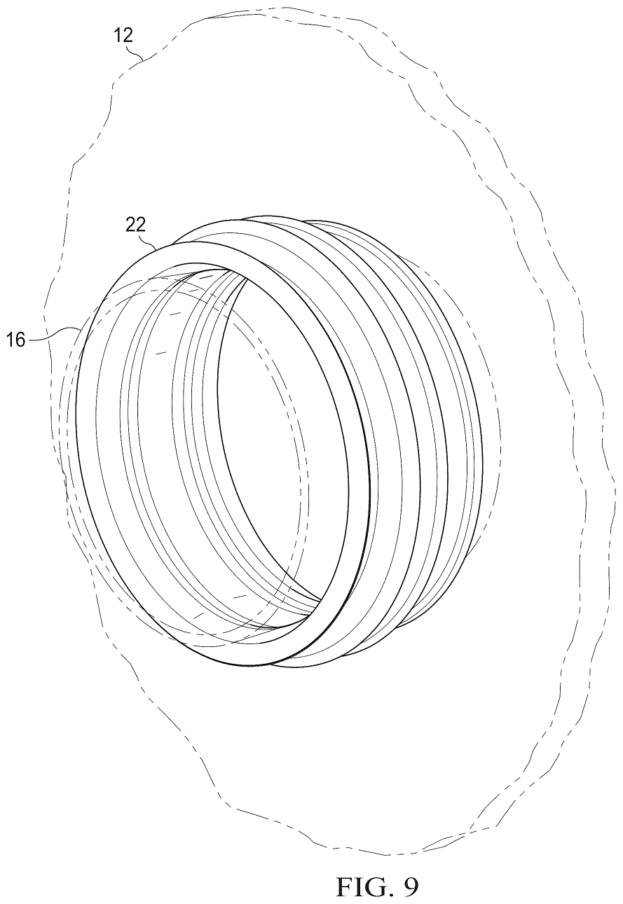

Reference will now be had to FIGS. 6-9 which help to explain the placement and operation of the connection seal of the invention. FIG. 6 shows the connection seal 22 installed on the manhole (tank) wall. The seal geometry is designed to seal against the flat surfaces of the tank, both inside and outside, and not on the cylindrical edge (generally at 14 in FIG. 1A), left rough by the hole cutting in the field. The seal features a mirrored geometry on both the inside and outside, creating redundancy of the sealing points. The seal is designed to be installed over variable wall thicknesses while maintaining contact around the entire circumference.

FIG. 7 shows the pipe spigot 16 inserted approximately halfway through the connection seal 22.

As has been described, the seal 22 incorporates a receiving and aligning cone geometry that ensures the alignment of the incoming pipe due to the presence of the pipe aligning cone regions 28, 30. This geometry interacts with the pipe chamfer to guide the pipe 16 into the correct position before the initial assembly begins. At the first stage of the pipe-seal interaction during assembly, the seal's geometry—the cone angle and the diameter of the contact ring surface with the tank wall—ensures that, under the right low-friction conditions, the outer part of the seal expands over the spigot while retracting in the opposite direction of the spigot's movement. This seemingly counter-intuitive movement pulls the inner section of the seal via the tension region 24. The connection seal climbs over the spigot, opening its ID and pulling the tension element against the insertion direction.

FIG. 8 shows the connection seal with the pipe spigot 16 fully inserted. In the second stage of the assembly, the spigot 16 pushes against and opens the inner section of the connection seal 22, stretching the tension region 24 even further. When the assembly is finished, the stretch in the tension region increases the contact pressure against both the tank wall 12 and the pipe 16.

FIG. 9 shows the assembled pipe 16 deflected 7°. The tension region of the connection seal balances forces when opposite load conditions occur on the inside and outside, such as in specific areas during deflection.

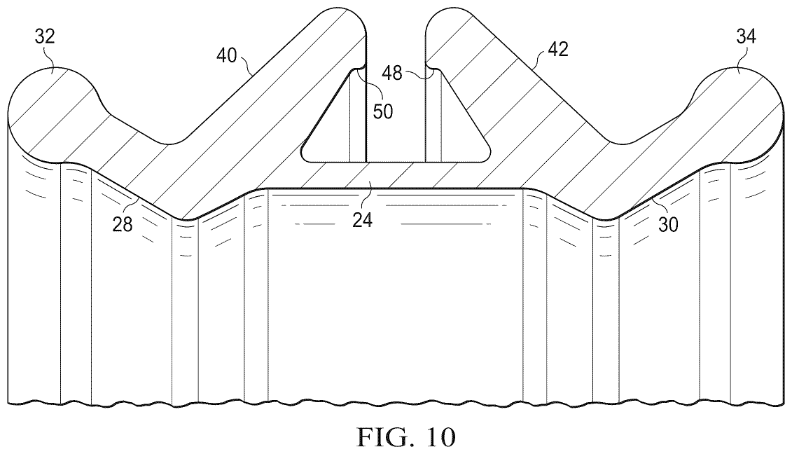

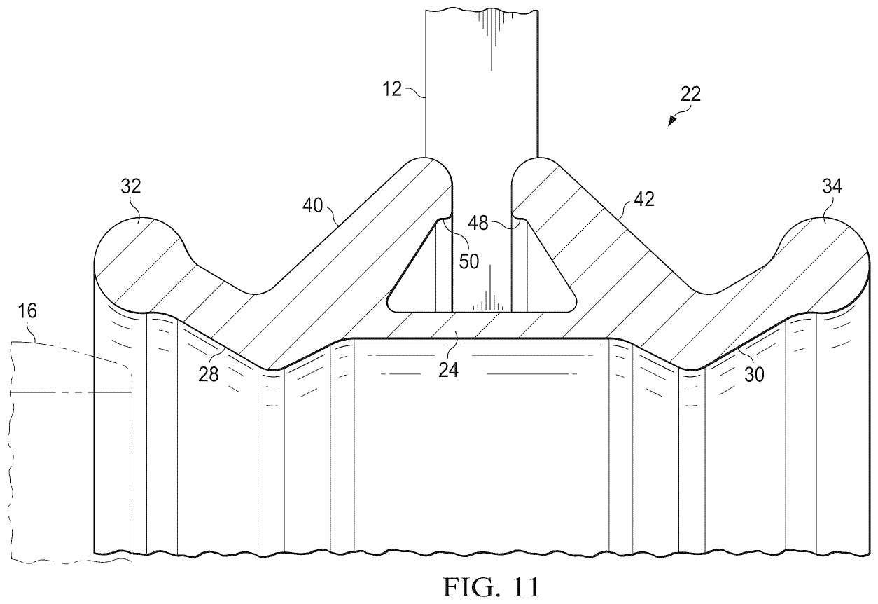

FIGS. 10-15 illustrate the pipe assembly and operation of the connection seal of the invention by way of cross sectional views through the seal. FIG. 11 is a cross sectional view showing the unloaded connection seal 22 of the invention superimposed over the tank wall 12. In other words, the seal is shown before assembly and in a relaxed state, rather than being stretched.

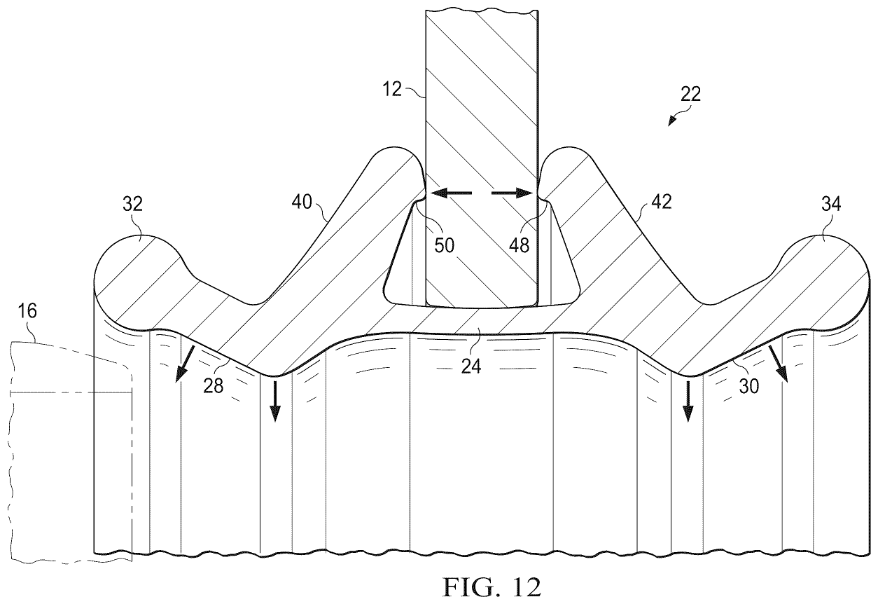

In FIG. 12, the connection seal is shown installed over the tank wall. The direction of the forces acting on the connection seal are illustrated by the arrows in FIG. 12. The rocker-type elements rotate, increasing the compression in the inner and outer sections of the seal, which enhances the reaction force against the tank wall. As the seal sections rotate during installation, the inner and outer internal diameters of the seal, along with the receiving cone angle, decrease, resulting in the final seal configuration being ready to receive the pipe spigot.

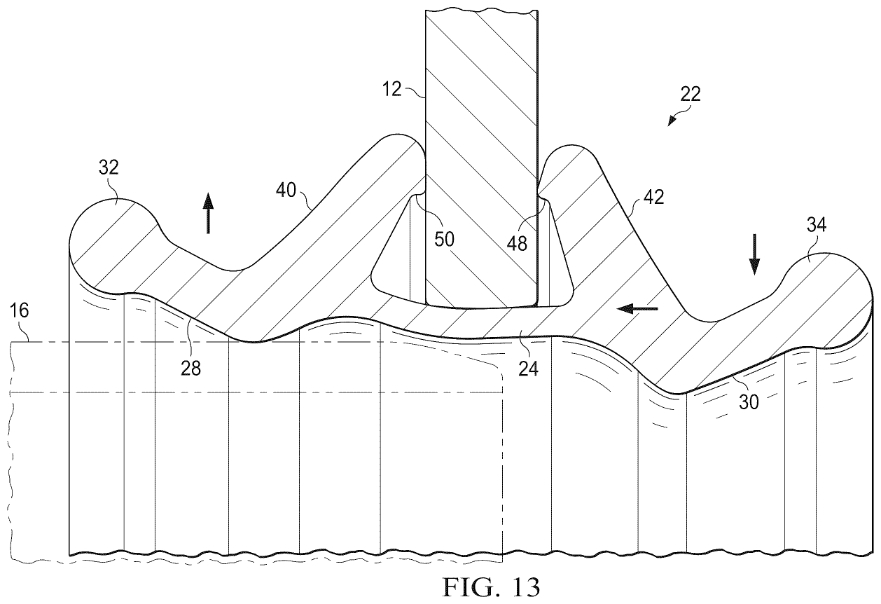

In FIG. 13, the connection seal is shown half-way through the sealing operation. As illustrated by the various arrows, the outer section of the seal has finished climbing over the spigot chamfer, reaching the spigot's outer diameter, while pulling the inner section outward.

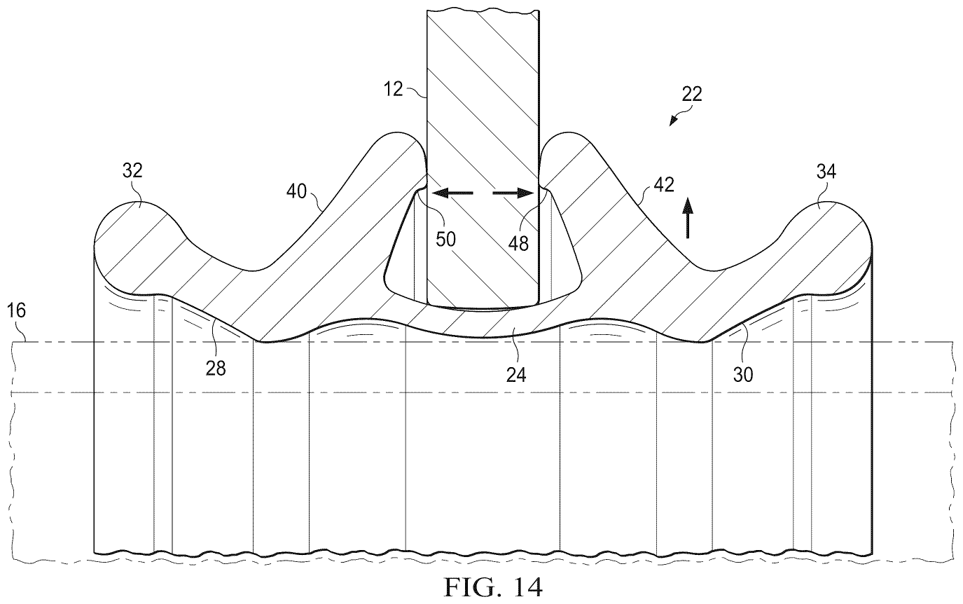

In FIG. 14, the connection seal is shown fully assembled. The pipe spigot 16 opens the inner seal section reaching the final assembled configuration. The geometries of the seal's outer and inner sections benefit from the stretch of the tension region 24, which helps them generate a strong reaction force against the tank wall 12.

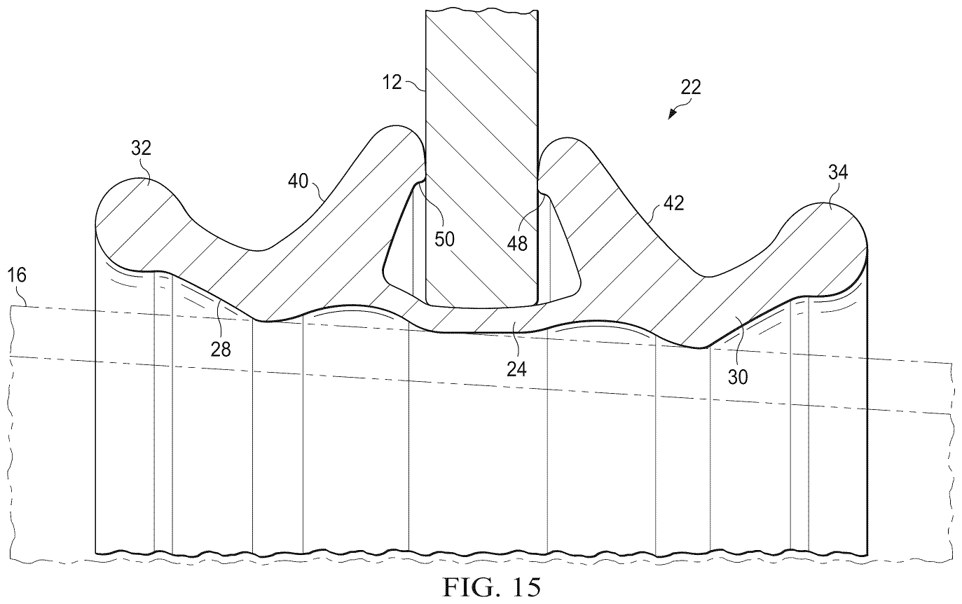

FIG. 15 shows the operation of the connection seal with pipe deflection. During deflection, some sections of the seal experience opposite loading conditions inside and outside the tank, as shown in the figure. The tension region balances the forces by being pulled on the closing side and pulling on the opening side, helping to prevent drops in the reaction force.

An invention has been provided with several advantages. The connection seal of the invention is relatively simple in design and economical to manufacture, being extrudable as an integral, homogeneous body of resilient elastomer. As such, it does not require the use of an external take-down clamp to provide a seal between the gasket body and a pipe or the associated additional parts which increase the number of installation steps. The connection seal of the invention does not require critical alignment during installation, or the use of equipment such as mechanical expansion units.

The connection seal also offers advantages over embedded gaskets of the type used in prior concrete piping systems by the very nature of the concrete casting process involved with embedded gaskets. The molding aspect of the manufacturing process adds to the cost and complexity of the job. The connection seal of the invention provides a less expensive method of installing sealing gaskets of this type within a wall opening in a manhole structure, which method is particularly suited for mass production or short notice.

While the invention has been shown in only one form, it is not thus limited but is susceptible to various changes and modifications without departing from the spirit thereof.

1. A maintenance hole connection seal for establishing a seal between an incoming pipe and a hole in a collection tank, the maintenance hole connection seal comprising:
a ring-shaped elastomeric body, the ring-shaped elastomeric body having a resilient circumferential tension region located at an approximate mid-point of the ring-shaped elastomeric body wherein the resilient circumferential tension region joins a pair of oppositely arranged, pipe aligning cone regions on a bottom circumferential surface of the ring-shaped elastomeric body, the pair of oppositely arranged, pipe aligning cone regions each terminating in an outer circumferential lip region at an outer extent thereof, the outer circumferential lip regions extending outwardly at an acute angle with respect to the bottom circumferential surface of the ring-shaped elastomeric body;
wherein the outer circumferential lip regions are each connected by a valley region to an inwardly extending rocker-type element on an upper circumferential surface of the ring-shaped elastomeric body, the inwardly extending rocker-type elements forming an obtuse angle with respect to the oppositely arranged lip regions, wherein the inwardly extending rocker-type elements are configured to be separated to define a lodging space, wherein the lodging space is configured to receive a variable thickness wall of the collection tank between the inwardly extending rocker-type elements, the variable thickness wall having respective flat interior and exterior surfaces, and wherein the inwardly extending rocker-type elements are configured to seal against the respective flat interior and exterior surfaces of the variable thickness tank wall.

2. The maintenance hole connection seal of claim 1, wherein each of the inwardly extending rocker-type elements has an upper tank wall sealing rib formed in an inner circumferential region thereof, the inner circumferential region being located above a respective void region, and wherein each upper tank wall sealing rib is configured to seal against respective flat interior and exterior surfaces of the variable thickness tank wall.

3. The maintenance hole connection seal of claim 2, wherein the lodging space created between the two inwardly extending rocker-type elements includes a vertical opening and oppositely arranged side void regions.

4. The maintenance hole connection seal of claim 1, wherein the ring-shaped elastomeric body, tension region, pipe aligning cone regions and outer circumferential lip region, and inwardly extending rocker-type elements are all integrally formed of a homogeneous resilient elastomeric material.

5. The maintenance hole connection seal of claim 4, wherein the ring-shaped elastomeric body, tension region, pipe aligning cone regions, outer circumferential lip regions, and inwardly extending rocker-type elements are all extruded and cut to a given length which defines a pair of free ends, the free ends then being joined to form the ring-shaped elastomeric body.

6. The maintenance hole connection seal of claim 1, wherein a region on the bottom circumferential surface of the maintenance hole connection seal joining the resilient circumferential tension region to the outer circumferential lip regions extends at an upward angle on either side of the resilient circumferential tension region to thereby form the pipe aligning cone region when a chamfered region of a plastic pipe is inserted within the ring-shaped elastomeric body.

7. The maintenance hole connection seal of claim 6, wherein the bottom circumferential surface of the maintenance hole connection seal defines a central, pipe receiving opening, and wherein the pipe aligning cone regions on the bottom circumferential surface of the maintenance hole connection seal terminate at pipe sealing surfaces at a point at which each of the cone regions joins the resilient circumferential tension region of the maintenance hole connection seal.

8. The maintenance hole connection seal of claim 7, wherein the maintenance hole connection seal is formed with a homogeneous elastomeric body and wherein a vertical axis drawn to bisect the resilient circumferential tension region of the connection seal body divides the body into a pair of symmetrical shapes, thereby providing sealing redundancy for the maintenance hole connection seal.

9. A method for establishing a seal between an incoming pipe and a hole in a maintenance hole collection tank, the method comprising the steps of:
providing a connection seal in the form of a ring-shaped elastomeric body which will constitute a primary sealing structure for the seal, the ring-shaped elastomeric body having a resilient circumferential tension region located at an approximate mid-point of the ring-shaped elastomeric body which tension region joins a pair of oppositely arranged, pipe aligning cone regions on a bottom circumferential surface of the ring-shaped elastomeric body, the pipe aligning cone regions each terminating in an outer circumferential lip region at an outer extent thereof, the outer circumferential lip regions extending outwardly at an acute angle with respect to the bottom circumferential surface of the ring-shaped elastomeric body;
wherein the outer circumferential lip regions are each connected by a valley region to an inwardly extending rocker-type element on an upper circumferential surface of the ring-shaped elastomeric body, the inwardly extending rocker-type elements forming an obtuse angle with respect to the pair of oppositely arranged grabbing handles, wherein the inwardly extending rocker-type elements are configured to be separated to define a lodging space, wherein the lodging space is configured to receive a variable thickness wall of the collection tank between the inwardly extending rocker-type elements, the variable thickness wall having respective flat interior and exterior surfaces, and wherein the inwardly extending rocker-type elements are configured to seal against the respective flat interior and exterior surfaces of the variable thickness tank wall.

10. The method of claim 9, wherein at least one hole is cut in a sidewall of the maintenance hole collection tank, the hole having a rough cylindrical edge left by the cutting of the hole, and wherein the lodging space created between the two inwardly extending rocker-type elements includes a vertical opening and oppositely arranged side void regions, the connection seal being installed in a previously provided hole in the tank wall of the maintenance hole collection tank so that it seals against flat surfaces of the tank interior and exterior walls rather than on the rough edge of a cylindrical wall opening in the collection tank wall.

11. The method of claim 10, wherein the connection seal features a mirrored geometry on both inside and outside, creating redundancy of sealing points.

12. The method of claim 11, wherein the connection seal is designed to be installed over variable wall thicknesses while maintaining contact around an entire circumferential surface of a hole opening in the maintenance hole collection tank.

13. The method of claim 12, wherein the connection seal incorporates a receiving and aligning cone geometry that ensures the alignment of the incoming pipe which is received within a tank opening, the aligning cone geometry interacting with a pipe chamfer to guide the pipe into a correct position for assembly.

14. The method of claim 13, wherein during a first stage of pipe-seal interaction during assembly of the seal within the collection tank opening, the connection seal's cone angles and diameter of the contact surface of the ring-shaped elastomeric body within the tank opening ensures that, under low-friction conditions, an outer part of the connection seal expands over the incoming pipe while the connection seal retracts in a direction which is opposite to the direction of the incoming pipe.

15. The method of claim 14, wherein this first stage of pipe-seal interaction pulls an inner section of the connection seal via the tension region of the seal, whereby the connection seal climbs over the incoming pipe, opening its internal diameter and pulling the tension region against the insertion direction.

16. The method of claim 15, wherein, in a second stage of the assembly, the incoming pipe pushes against and opens the inner section of the connection seal, stretching the tension region even further.

17. The method of claim 16, wherein once assembly is finished, the stretch in the tension region of the connection seal serves to increase contact pressure against both the tank wall and the incoming pipe.

18. The method of claim 17, wherein the tension region of the connection seal helps to balance forces when opposite load conditions occur on the inside and outside, such as in specific areas of the seal during deflection of the incoming pipe.

19. The method of claim 18, wherein the elastomeric body, tension region, pipe aligning cone regions and outer circumferential lip region, and inwardly extending rocker-type elements are all extruded and cut to a given length which defines a pair of free ends, the free ends then being joined to form a ring-shaped body.

20. The method of claim 9, wherein each of the inwardly extending rocker-type elements has an upper tank wall sealing rib formed in an inner circumferential region thereof, the inner circumferential region being located above a respective void region, and wherein each upper tank wall sealing rib is configured to seal against respective flat interior and exterior surfaces of the variable thickness tank wall.
